(19) United States
(12) Patent Application Publication
(10) Pub. No.: US 2026/0028455 A1
(43) Pub. Date: Jan. 29, 2026

(54) SOIL CONDITIONER

(71) Applicant: NIPPON PAPER INDUSTRIES CO., LTD., Tokyo (JP)

(72) Inventors: Akira SHIBATA, Tokyo (JP); Akihiko NAKAMURA, Tokyo (JP)

(73) Assignee: NIPPON PAPER INDUSTRIES CO., LTD., Tokyo (JP)

(21) Appl. No.: 18/994,205

(22) PCT Filed: Jul. 18, 2023
(86) PCT No.: PCT/JP2023/026256

§ 371 Date: Jan. 14, 2025

(30) Foreign Application Priority Data
Jul. 20, 2022 (JP) 2022-115287
Mar. 1, 2023 (JP) 2023-030760

(51) Int. Cl. C08H 7/00; A01C 21/00; C05F 11/00; C05G 3/80; C08G 81/00; C09K 17/32

(52) U.S. Cl. CPC C08H 6/00; C05F 11/00; C05G 3/80; C08G 81/00; C09K 17/32; A01C 21/00

(57) ABSTRACT

A soil conditioner including a lignin-based compound as an active ingredient and capable of efficiently increasing the amount of microorganisms and inorganic components in soil. The soil conditioner includes a lignin sulfonic acid having a phenolic hydroxyl group content of 0.1% to 5.0% by weight, a methoxyl group content of 1.0% to 15.0% by weight, and a sulfone group-derived sulfur atom content of 2.0% by weight or higher. An improved soil composition, including the soil conditioner and soil; a method for preparing improved soil, including adding the soil conditioner to soil; and a plant production method in which a plant is produced with the improved soil composition are also described.

### FIELD

The present invention relates to a soil conditioner.

### BACKGROUND

The properties of soil are important in agriculture and other industries in which soil is used. In particular, soil rich in microorganisms and inorganic components has advantages, such as the prevention of crop diseases, the prevention of an injury by continuous cropping, and the realization of organic agriculture, in the cultivation of crops by the use of the soil.

For example, Patent Literature 1 describes a soil conditioner that reduces soil hardness, the soil conditioner including a lignin degradation product such as soda lignin as an active ingredient and having an aldehyde yield caused by alkali nitrobenzene oxidation of 5% by mass or higher, a weight average molecular weight of 300 or more and 100,000 or less, and a contact angle to water of 15° or larger. Patent Literature 2 describes a soil conditioner that promotes aggregate while maintaining a structure of soil microbial flora, the soil conditioner containing a lignin derivative extracted from a lignin-containing material by using a solvent including a predetermined organic solvent.

### CITATION LIST

### Patent Literature

Patent Literature 1: Japanese Patent Application Laid-open No. 2017-190448
Patent Literature 2: Japanese Patent Application Laid-open No. 2021-80367

### SUMMARY

### Technical Problem

However, Patent Literature 1 and Patent Literature 2 do not describe any effect of causing the growth of microorganisms in soil and an increase in inorganic components. An object of the present invention is to provide a soil conditioner including a lignin-based compound as an active ingredient and being capable of efficiently increasing the amount of microorganisms and the amount of inorganic components in soil.

### Solution to Problem

The present invention provides the following [1] to [10].
[1] A soil conditioner, comprising a lignin sulfonic acid having a phenolic hydroxyl group content of 0.1% to 5.0% by weight, a methoxyl group content of 1.0% to 15.0% by weight, and a sulfone group-derived sulfur atom content of 2.0% or higher.
[2] The soil conditioner according to claim [1], wherein the lignin sulfonic acid has at least one of:
   a sulfur atom content of 1.0% by weight or higher,
   a sodium atom content of 0.3% by weight or higher, and
   a reducing sugar content of 0.1% by weight or higher.
[3] The soil conditioner according to claim [1] or [2], wherein the lignin sulfonic acid has a carboxyl group content of 0.1 to 4.5 mmol/g.
[4] The soil conditioner according to any one of claims [1] to [3], wherein a weight average molecular weight (RI) of the lignin sulfonic acid is 3,000 or more.
[5] The soil conditioner according to any one of claims [1] to [4], wherein the lignin sulfonic acid comprises a substituent derived from (poly)alkylene oxide.
[6] The soil conditioner according to any one of claims [1] to [5], wherein soil is agricultural soil.
[7] A biostimulant for soil, comprising a lignin sulfonic acid having a phenolic hydroxyl group content of 0.1% to 5.0% by weight, a methoxyl group content of 1.0% to 15.0% by weight, and a sulfone group-derived sulfur atom content of 2.0% or higher.
[8] An improved soil composition, comprising:
   the soil conditioner according to any one of claims [1] to [6] or the biostimulant according to claim [7]; and soil.
[9] A method for preparing improved soil, the method comprising adding the soil conditioner according to any one of claims [1] to [6] or the biostimulant according to claim [7] to soil.
[10] A plant production method, wherein a plant is produced by using the improved soil composition according to claim [8].
[11] Use of a lignin sulfonic acid for producing a soil conditioner or a biostimulant, wherein the lignin sulfonic acid has a phenolic hydroxyl group content of 0.1% to 5.0% by weight, a methoxyl group content of 1.0% to 15.0% by weight, and a sulfone group-derived sulfur atom content of 2.0% or higher.

### Advantageous Effects of Invention

The present invention provides a soil conditioner applicable to various types of soils. The soil conditioner according to the present invention is capable of causing the growth of microorganisms in soil and increasing inorganic components. Therefore, when used in the agricultural field, the soil conditioner can lead to an increased crop yield and realize and popularize organic agriculture.

### DESCRIPTION OF EMBODIMENTS

### [1. Lignin Sulfonic Acid Component]

A soil conditioner according to the present invention comprises a lignin sulfonic acid component.

### [Lignin Sulfonic Acid]

The lignin sulfonic acid component mainly comprises lignin sulfonic acid and is usually derived from sulfite cooking of pulp. Lignin sulfonic acid is a compound having a skeleton in which a sulfone group is introduced by the cleavage of carbon at the a-position of a side chain in the hydroxyphenylpropane structure of lignin.

Lignin sulfonic acid can be in the form of a salt. Examples of the salt may include monovalent metal salts, divalent metal salts, ammonium salts, and organic ammonium salts. Among these salts, a calcium salt, a magnesium salt, a sodium salt, and a mixed salt of calcium and sodium are preferred.

### [Substituent]

Lignin sulfonic acid comprises a substituent other than the sulfone group. The substituent may be a lignin-derived substituent or may be a substituent that is not originally included in lignin, but is introduced by modification treatment. Examples of the substituent may include hydroxyl groups (a phenolic hydroxyl group, an alcoholic hydroxyl group), a methoxyl group, a carboxyl group, a sulfomethyl group, an aminomethyl group, and a (poly)alkylene oxide group. Among these substituents, a phenolic hydroxyl group, a methoxyl group, a sulfone group, or a (poly)alkylene oxide group is more preferably comprised within a predetermined range. Thus, plant growth can be promoted.

### —Phenolic Hydroxyl Group—

The phenolic hydroxyl group is generally a hydroxyl group bound directly to an aromatic ring such as benzene. The content of the phenolic hydroxyl group is preferably 0.1% by weight or higher, more preferably 0.5% by weight or higher, still more preferably 1.0% by weight or higher, still more preferably 1.1% by weight or higher with respect to the total weight of the lignin sulfonic acid component. The upper limit of the content of the phenolic hydroxyl group is preferably 5.0% by weight or lower, more preferably 4.0% by weight or lower, still more preferably 3.0% by weight or lower, still more preferably 2.7% by weight or lower. Hence, the content of the phenolic hydroxyl group in the lignin sulfonic acid is preferably 0.1% to 5.0% by weight, more preferably 0.5% to 4.0% by weight, still more preferably 1.0% to 3.0% by weight, still more preferably 1.1% to 2.7% by weight. The content of the phenolic hydroxyl group can be determined from a value of absorbance measured using a spectrophotometer.

### —Methoxyl Group—

The methoxyl group is a group represented by a formula: —OCH₃. The content of the methoxyl group is preferably 1.0% by weight or higher, more preferably 3.0% by weight or higher, still more preferably 5.0% by weight or higher, still more preferably 6.0% by weight or higher with respect to the total weight of the lignin sulfonic acid component. The upper limit of the content of the methoxyl group is preferably 15.0% by weight or lower, more preferably 13.0% by weight or lower, still more preferably 12.0% by weight or lower, still more preferably 11.5% by weight or lower. Hence, the content of the methoxyl group is preferably 1.0% to 15.0% by weight, more preferably 3.0% to 13.0% by weight, still more preferably 5.0% to 12.0% by weight, still more preferably 6.0% to 11.5% by weight. The methoxyl group content of lignin can be measured by the Viebock and Schwappach method.

### —Sulfone Group—

A sulfone group (sulfonic acid group, sulfo group) is a group generally represented by a formula: —SO₃⁻M⁺ (M is a counter cation (for example, H, Na, Ca, Mg, or NH₄)). The content of the sulfone group can be expressed by the content of sulfur atom derived from the sulfone group (the content of S in the sulfone group). The content of S in the sulfone group is preferably 2.0% or higher, more preferably 3.0% or higher, still more preferably 4.0% or higher, still more preferably 4.5% or higher, with respect to the total amount of the lignin sulfonic acid component. The upper limit of the content of S in the sulfone group is not particularly limited and is preferably 10.0% or lower, more preferably 9.0% or lower, still more preferably 8.0% or lower, still more preferably 7.0% or lower. Hence, the content of S in the sulfone group is preferably 2.0% to 10.0%, more preferably 3.0% to 9.0%, still more preferably 4.0% to 8.0%, still more preferably 4.5% to 7.0%. The content of S in the sulfone group can be determined by subtracting the content of sulfur atoms in an inorganic form from the content of all sulfur atoms in the lignin sulfonic acid.

### —Carboxyl Group—

The carboxyl group is a group generally represented by a formula: —COOM⁺ (M is a counter cation (for example, H, Na, Ca, Mg, NH₄)). The content of the carboxyl group is preferably within a predetermined range. That is, the content of the carboxyl group is preferably 0.1 mmol/g or more, more preferably 0.3 mmol/g or more, still more preferably 0.5 mmol/g or more with respect to the weight of the lignin sulfonic acid component. The upper limit of the content of the carboxyl group is preferably 4.5 mmol/g or less, more preferably 4.0 mmol/g or less, still more preferably 3.0 mmol/g or less. Hence, the content of the carboxyl group is preferably 0.1 to 4.5 mmol/g, more preferably 0.3 to 4.0 mmol/g, still more preferably 0.5 to 3.0 mmol/g. The content of the carboxyl group can be determined by neutralization titration.

### —(Poly)alkylene Glycol Group—

The (poly)alkylene glycol group is a substituent derived from (poly)alkylene oxide. The average number of moles of an alkylene oxide unit added, the alkylene oxide unit constituting polyalkylene glycol, is usually 1 or larger, 5 or larger, or 10 or larger, preferably 15 or larger, more preferably 20 or larger, still more preferably 25 or larger or 30 or larger, still more preferably 35 or larger. Thus, good dispersibility can be achieved. In particular, the average number of moles of the alkylene oxide unit added is preferably 50 or larger, 60 or larger, 70 or larger, 80 or larger, or 90 or larger because spreadability on a water surface can be further enhanced. The upper limit of the average number of moles of the alkylene oxide unit added is usually 300 or less or 200 or less, preferably 190 or less, more preferably 180 or less, still more preferably 170 or less. Thus, dispersion retention can be prevented from decreasing. Hence, the average number of moles added is usually 10 to 200, preferably 15 to 190, more preferably 20 to 180, still more preferably 25 to 170. On the other hand, the average number of moles added may be preferably 25 to 300, more preferably 30 to 200, still more preferably 35 to 150. The number of carbon atoms of the polyalkylene glycol is not particularly limited and is usually 2 to 18, preferably 2 to 4, more preferably 2 to 3. Examples of the alkylene oxide unit may include an ethylene oxide unit, a propylene oxide unit, and a butylene oxide unit. An ethylene oxide unit or a propylene oxide unit is preferred. Examples of the lignin sulfonic acid including the (poly)alkylene oxide group may include a lignin derivative described in WO 2021/066166.

### [Inorganic Component]

The lignin sulfonic acid component may further include an inorganic component. Examples of the inorganic component may include inorganic salts, such as sulfur, calcium, sodium, magnesium, nitrogen, phosphorus, potassium, and iron, ammonia, oxides of the inorganic salts (such as sulfur oxide, magnesium oxide, and calcium oxide), hydroxides of the inorganic salts (such as magnesium hydroxide, calcium hydroxide, sodium hydroxide, and ammonium hydroxide), carbonates of the inorganic salts (such as calcium carbonate and sodium carbonate), and nitric acid. The aspect of the inorganic component is not particularly limited and may be a counter cation of the lignin sulfonic acid or a free inorganic component (for example, an inorganic component added during the production of the lignin sulfonic acid). Among them, at least one of sulfur, calcium, sodium, magnesium, nitrogen, phosphorus, and potassium is preferably included.

### —Sulfur Ion—

The content of sulfur ions can be expressed as the content of sulfur atoms (the total S content) in the lignin sulfonic acid. The total S content is preferably 1.0% by weight or higher, 2.0% by weight or higher, or 3.0% by weight or higher, more preferably 4.0% by weight or higher, still more preferably 5.0% by weight or higher. The upper limit of the total S content is not particularly limited and is preferably 10.0% by weight or lower, more preferably 9.0% by weight or lower, still more preferably 8.0% by weight or lower. Hence, the S content is preferably 1.0% to 10.0% by weight, 2.0% to 10.0% by weight, or 3.0% to 10.0% by weight, more preferably 4.0% to 9.0% by weight, still more preferably 5.0% to 8.0% by weight. The total S content can be determined by ICP emission spectrometry.

### —Sulfur Oxide—

The lignin sulfonic acid may include sulfur oxide. Examples of the sulfur oxide may include sulfur dioxide (SO₂), sulfur trioxide (SO₃), and sulfur tetroxide (SO₄). SO₃ and SO₄ are preferred. There is a possibility that SO₃ changes into the form of SO₄, and the content of SO₃ is usually 0% by weight or higher, preferably 0.001% by weight or higher, more preferably 0.005% by weight or higher, still more preferably 0.01% by weight or higher or 0.04% by weight or higher. The upper limit of the content of SO₃ is preferably 3.0% by weight or lower, more preferably 2.0% by weight or lower, still more preferably 1.0% by weight or lower, still more preferably 0.5% by weight or lower. Hence, the content of SO₃ is usually 0% to 3.0% by weight, preferably 0.001% to 3.0% by weight, more preferably 0.005% to 2.0% by weight, still more preferably 0.01% to 1.0% by weight, still more preferably 0.04% to 0.5% by weight. The content of SO₄ is preferably 0.2% by weight or higher, more preferably 0.4% by weight or higher, still more preferably 0.5% by weight or higher, 2.0% by weight or higher, or 3.0% by weight or higher. The upper limit of the content of SO₄ is preferably 10% by weight or lower, more preferably 9.5% by weight or lower, still more preferably 9.0% by weight or lower. Hence, the content of SO₄ is preferably 0.2% to 10% by weight, more preferably 0.4% to 9.5% by weight, still more preferably 0.5% to 9.0% by weight, still more preferably 2.0% to 9.0% by weight or 3.0% to 9.0% by weight. The content of the sulfur oxide can be determined by ion chromatography.

### —Ratio of Sulfone Group-Derived S Content to Total S Content—

The ratio of the content of sulfone group-derived sulfur atoms relative the content of sulfur atoms in the lignin sulfonic acid is preferably 0.5 or more, more preferably 0.6 or more. The upper limit of the ratio is not particularly limited and is usually 0.9 or less, preferably 0.8 or less.

—Ratio of SO₃ to SO₄—

The ratio of the content of SO₃ relative to the content of SO₄ in the lignin sulfonic acid is usually 0 or more, preferably 0.01 or more, more preferably 0.02 or more. The upper limit of the ratio is preferably 0.05 or less, more preferably less than 0.03.

### —Sodium Ion, Calcium Ion, and Magnesium Ion—

The Na⁺ ion content, the Ca²⁺ ion content, and the Mg²⁺ ion content can be expressed as their respective atomic contents. The sodium atom content (Na content) is preferably 0.3% by weight or higher, more preferably 0.5% by weight or higher, still more preferably 1.0% by weight or higher. The upper limit of the Na content is not particularly limited and is preferably 10.0% by weight or lower, more preferably 9.0% by weight or lower, still more preferably 8.0% by weight or lower. Hence, the Na content is preferably 0.3% to 10.0% by weight, more preferably 0.5% to 9.0% by weight, still more preferably 1.0% to 8.0% by weight. The calcium atom content (Ca content) is preferably 0.001% by weight or higher, more preferably 0.01% by weight or higher, still more preferably 0.03% by weight or higher. The upper limit of the Ca content is preferably 3.0% by weight or lower, more preferably 1.0% by weight or lower. Hence, the Ca content is preferably 0.001% to 3.0% by weight, more preferably 0.01% to 1.0% by weight, still more preferably 0.03% to 1.0% by weight. The magnesium atom content (Mg content) is preferably 0.05% by weight or higher, more preferably 0.07% by weight or higher, still more preferably 0.1% by weight or higher, 0.5% by weight or higher, 1.0% by weight or higher, 2.0% by weight or higher, 3.0% by weight or higher, or 3.2% by weight or higher. The upper limit of the Mg content is preferably 10.0% by weight or lower, more preferably 8.0% by weight or lower, still more preferably 5.0% by weight or lower. Hence, the Mg content is preferably 0.05% to 10.0% by weight, more preferably 0.07% to 8.0% by weight, still more preferably 0.1% to 5.0% by weight, 0.5% to 5.0% by weight, 1.0% to 5.0% by weight, 2.0% to 5.0% by weight, 3.0% to 5.0% by weight, or 3.2% to 5.0% by weight. The Na content, the Ca content, and the Mg content can be determined by the inductively coupled plasma (ICP) method.

### —Reducing Sugars—

The lignin sulfonic acid component preferably further includes a reducing sugar. In the present specification, reducing sugars refer to saccharides having reducing properties, that is, the property of producing an aldehyde group or a ketone group in a basic solution. Examples of the reducing sugars may include: all types of monosaccharides; disaccharides, such as maltose, lactose, arabinose, and sucrose invert sugars; and polysaccharides. The reducing sugars usually include cellulose, hemicellulose, and degradation products thereof. Examples of the degradation products of cellulose and hemicellulose may include: monosaccharides, such as rhamnose, galactose, arabinose, xylose, glucose, mannose, and fructose; oligosaccharides, such as xylooligosaccharides and cellooligosaccharides; and modified products thereof. The modified products are chemically modified products such as oxides and sulfonated products, and examples thereof may include: sugar derivatives in which a functional group, such as a hydroxyl group, an aldehyde group, a carbonyl group, or a sulfo group, is introduced into a sugar skeleton; and compounds in which two or more (types) of the sugar derivatives are bound to each other.

The reducing-sugar content is preferably 0.1% by weight or higher, more preferably 0.3% by weight or higher, still more preferably 0.5% by weight or higher or 2.0% by weight or higher. The upper limit of the reducing-sugar content is preferably 35% by weight or lower, more preferably 30% by weight or lower, still more preferably 25% by weight or lower. Hence, the reducing-sugar content is preferably 0.1% to 35% by weight, more preferably 0.3% to 30% by weight, still more preferably 0.5% to 25% by weight or 2.0% to 25% by weight. The reducing-sugar content can be calculated in terms of glucose content by the Somogyi-Schaffer method.

### [Other Components]

The lignin sulfonic acid component may include components other than the above-mentioned components. Examples of the other components may include an organic component and ash. Examples of the organic component may include low-molecular weight organic substances (for example, an organic acid having 5 or fewer carbon atoms), such as formic acid, acetic acid, propionic acid, valeric acid, pyruvic acid, succinic acid, and lactic acid. The low-molecular weight organic substances may be included alone or in combination of two or more types thereof.

The low-molecular weight organic substance content is preferably 0.01% by weight or higher, more preferably 0.1% by weight or higher, still more preferably 1% by weight or higher. The upper limit of the low-molecular weight organic substance content is preferably 25% by weight or lower, more preferably 20% by weight or lower, still more preferably 15% by weight or lower. Hence, the low-molecular weight organic substance content is preferably 0.01% to 25% by weight, more preferably 0.1% to 20% by weight, still more preferably 1% to 15% by weight. The low-molecular weight organic substance content can be measured, for example, as the amount of acetic acid fraction in the fractional quantification of organic acid by silica gel column chromatography by ether extraction.

### [Weight Average Molecular Weight (RI)]

The weight average molecular weight (RI) of the lignin sulfonic acid component is preferably 3,000 or higher, more preferably 3,500 or higher, still more preferably 3,700 or higher, still more preferably 4,000 or higher. The upper limit of the weight average molecular weight (RI) is not particularly limited and is preferably 50,000 or lower, more preferably 40,000 or lower, still more preferably 35,000 or lower. Hence, the weight average molecular weight (RI) is preferably 3,000 to 50,000, more preferably 3,500 to 50,000, still more preferably 3,700 to 40,000, still more preferably 4,000 to 35,000. In the present specification, the weight average molecular weight (RI) is a weight average molecular weight determined by GPC using a refractive index detector (RI).

### [Weight Average Molecular Weight (UV)]

The weight average molecular weight (UV) of the lignin sulfonic acid component is preferably 4,000 or higher, more preferably 5,000 or higher, still more preferably 6,000 or higher. The upper limit of the weight average molecular weight (UV) is not particularly limited and is preferably 70,000 or lower, more preferably 60,000 or lower, still more preferably 50,000 or lower. Hence, the weight average molecular weight (UV) is preferably 4,000 to 70,000, more preferably 5,000 to 60,000, still more preferably 6,000 to 50,000. In the present specification, the weight average molecular weight (UV) is a weight average molecular weight determined by GPC using an ultraviolet-visible absorbance detector.

### —Ratio of Weight Average Molecular Weight RI/UV—

The ratio of the weight average molecular weight (RI) to the weight average molecular weight (UV) is preferably 0.95 or lower, and more preferably 0.93 or lower. The lower limit of the ratio is not particularly limited and is usually 0.4 or higher, preferably 0.5 or higher.

As the lignin sulfonic acid component, for example, a product having the above-mentioned content of the substituent and the inorganic component may be selected from SanLighon series (to be marketed by Nippon Paper Industries Co., Ltd. in and after July 2022) and used.

### [1.2 Method for Producing Lignin Sulfonic Acid Component]

Although a method for producing the lignin sulfonic acid component is not particularly limited, the lignin sulfonic acid component can be produced, for example, by sulfite treatment of a lignocellulosic raw material or by decomposing and thereby sulfonating lignin. By adjusting production conditions, the type and content of a substituent in the lignin sulfonic acid component and the type and content of each component, such as an inorganic component or reducing sugars, can be adjusted.

### —Raw Material—

The lignocellulosic raw material as one example of a raw material is not particularly limited as long as the lignocellulosic raw material includes lignocellulose in its composition. Examples of the lignocellulosic raw material may include pulp materials such as wood and non-wood. Examples of the wood may include: conifer wood, such as Pinus radiata, Yezo spruce, Japanese red pine, cedar, and cypress; and hardwood, such as white birch and beech. Any age and any part of the wood can be used. Therefore, woods collected from trees that are different in age or woods collected from different parts of a tree may be used in combination. Examples of the non-wood may include bamboo, kenaf, reed, and rice plant. These lignocellulose raw materials can be used alone or in combination of two or more types thereof.

Examples of lignin as another example of the raw material may include naturally occurring substances and artificially produced materials (for example, a dehydrogenation polymer of hydroxy cinnamyl alcohol analogue).

### —Sulfite Treatment—

Sulfite treatment can be performed by bringing at least one of sulfurous acid and sulfite salt into contact with the lignocellulosic raw material. Conditions for the sulfite treatment are not particularly limited as long as a sulfo group can be introduced into an a-carbon atom of a side chain of lignin included in the lignocellulosic raw material.

The sulfite treatment is preferably performed by sulfite cooking. Thus, lignin in the lignocellulosic raw material can be more quantitatively sulfonated. Sulfite cooking is a method in which the lignocellulosic raw material is subjected to a reaction at high temperature in a solution (for example, a water solution or a cooking liquid) of at least one of sulfurous acid and sulfite salt. The method is advantageous in terms of cost-effectiveness and ease of implementation because the method has been industrially established and practiced as a method for producing sulfite pulp.

Examples of the sulfite salt for performing sulfite cooking may include magnesium salts, calcium salts, sodium salts, and ammonium salts.

The concentration of sulfurous acid (SO₂) in a solution of at least one of sulfurous acid and sulfite salt is not particularly limited, but the ratio of the mass (g) of SO₂ with respect to 100 mL of a reaction chemical solution is preferably 1 g/100 mL or more, and, for performing sulfite cooking, the ratio thereof is more preferably 2 g/100 mL or more. The upper limit of the ratio is preferably 20 g/100 mL or less, and, for performing sulfite cooking, the upper limit thereof is more preferably 15 g/100 mL or less. The concentration of SO₂ is preferably 1 g/100 mL to 20 g/100 mL, and, for performing sulfite cooking, the concentration of SO₂ is more preferably 2 g/100 mL to 15 g/100 mL.

A pH value in the sulfite treatment is not particularly limited and is usually 10 or less. Sulfite cooking, if performed, is preferably performed under acidic conditions, more preferably at pH 5 or less, still more preferably at pH 3 or less. Thus, a lignin derivative (for example, lignin sulfonic acid) can be obtained more efficiently, which results in achievement of higher quality pulp. The lower limit of the pH value is preferably 0.1 or more, and, for performing sulfite cooking, the lower limit thereof is more preferably 0.5 or more. The pH value in the sulfite treatment is preferably 0.1 to 10, and, for performing sulfite cooking, the pH value is more preferably 0.5 to 5, still more preferably 0.5 to 3.

The temperature of the sulfite treatment is not particularly limited and is preferably 170° C. or lower, and, for performing sulfite cooking, the temperature is more preferably 150° C. or lower. The lower limit of the temperature of the sulfite treatment is preferably 70° C. or higher, and, for performing sulfite cooking, the lower limit thereof is more preferably 100° C. or higher. The temperature condition for the sulfite treatment is preferably 70° C. to 170° C., and, for performing sulfite cooking, the temperature condition is more preferably 100° C. to 150° C.

The treatment time of the sulfite treatment is not particularly limited and depends on sulfite treatment conditions, but is preferably 0.5 to 24 hours, more preferably 1.0 to 12 hours.

In the sulfite treatment, a compound capable of providing a counter cation is preferably added to the lignin sulfonic acid. With the addition of the compound capable of providing a counter cation, the pH value in the sulfite treatment can be kept constant. Examples of the compound capable of providing a counter cation may include MgO, Mg(OH)₂, CaO, Ca(OH)₂, CaCO₃, NH₃, NH₄OH, NaOH, NaHCO₃, and Na₂CO₃. The counter cation is preferably a magnesium ion or a sodium ion.

When a solution of at least one of sulfurous acid and sulfite salt is used in the sulfite treatment, besides SO₂, the solution may include the above-mentioned counter cation (salt) and a cooking penetrating agent (for example, a cyclic ketone compound, such as anthraquinone sulfonate, anthraquinone, or tetrahydroanthraquinone) as necessary.

There is no limitation on equipment used for the sulfite treatment. For example, commonly known dissolving-pulp production equipment can be used.

Separation of an intermediate product from a solution of at least one of sulfurous acid and sulfite acid can be performed in accordance with a usual method. Examples of a method for the separation may include a method for separating a sulfite cooking waste liquid after sulfite cooking (for example, filtration).

The lignin sulfonic acid obtained by the sulfite treatment (for example, obtained as a filtrate or a filtration residue, preferably a filtrate, after the filtration of insoluble substances contained in a sulfurous acid solution) may be used as it is or concentrated as necessary and used as the lignin sulfonic acid component being an active ingredient. On the other hand, another treatment may be further performed as necessary. Thus, purity can be enhanced or other substituents not originally present in a raw material can be introduced. Examples of the other treatment may include alkaline treatment, oxidation treatment, dialysis treatment, ultrafiltration treatment, modification treatment, and combinations thereof.

### (Alkaline Treatment)

The alkaline treatment is beneficially performed by placing a target sample under alkaline conditions. Placing the target sample under alkaline conditions means placing the target sample in a water solution usually having a pH value of 8 or higher, preferably having a pH value of 9 or higher. The upper limit of the pH value is usually 14.

In the alkaline treatment, an alkaline substance is usually brought into contact with a sulfite-treated material. The alkaline substance is not particularly limited and examples thereof may include calcium hydroxide, magnesium hydroxide, sodium hydroxide, potassium hydroxide, sodium carbonate, and ammonia. Among them, sodium hydroxide and calcium hydroxide are preferably used. The alkaline substances may be used alone or in combination of two or more types thereof.

Examples of a method for bringing the alkaline substance into contact with the sulfite-treated material may include a method in which a dispersion or a solution (for example, a water dispersion or a water solution) of the sulfite-treated material is prepared and the alkaline substance is added to the dispersion or the solution and a method in which a solution or a dispersion (for example, a water dispersion or a water solution) of the alkaline substance is added to the sulfite-treated material.

The temperature of the alkaline treatment is not particularly limited and is preferably 40° C. or higher, more preferably 60° C. or higher. The upper limit of the temperature of the alkaline treatment is preferably 150° C. or lower, more preferably 120° C. or lower, still more preferably 110° C. or lower.

The amount of the alkaline substance in the alkaline treatment is preferably 0.5% to 40% by mass, more preferably 1.0% to 30% by mass, with respect to the mass of the solid contents of the sulfite-treated material or with respect to the mass of a water solution or a dispersion obtained by dispersing an alkaline-treated extract in an aqueous solvent (for example, water).

The time of the alkaline treatment is not particularly limited and is preferably 0.1 hours or longer, more preferably 0.5 hours or longer. The upper limit of the time is preferably 10 hours or shorter, more preferably 6 hours or shorter.

Prior to the alkaline treatment, the dissolution, the dispersion treatment, and the concentration adjustment of the sulfite-treated material (the preparation of a solution of an aqueous solvent such as water or a dispersion) may be performed as necessary. The dispersion treatment can be performed, for example, by passing through a disc refiner, by addition to a mixer or a disperser, or by kneading treatment. The concentration adjustment can be performed, for example, using an aqueous solvent such as water.

### (Oxidation Treatment)

The oxidation treatment can be performed for a treated product obtained after the sulfite treatment (for example, a filtrate after filtration) or a treated product obtained after the alkaline treatment. The oxidation treatment is beneficially performed suitably using an oxidant. In the case of using an oxidant gas, the oxidation treatment can be performed by causing the gas to pass through a filtrate. In the case of using a liquid oxidant, the oxidation treatment can be performed by adding the liquid to a filtration residue or a filtrate. As the oxidant, air, oxygen, hydrogen peroxide, ozone, or a combination thereof is preferably used. The oxidation treatment is preferably performed under alkaline conditions (alkaline oxidation treatment). The pH for the alkaline oxidation treatment is usually 8 or more, preferably 10 or more, more preferably 12 or more. The temperature of the oxidation treatment is usually 20° C. to 200° C., preferably 50° C. to 180° C. The time of the oxidation treatment is usually 0.1 hours or longer, more preferably 0.5 hours or longer. The upper limit of the time is preferably 5 hours or shorter, more preferably 3 hours or shorter.

### (Dialysis Treatment or UF Treatment)

The dialysis treatment can be performed for a treated product obtained after the sulfite treatment (for example, a filtrate after filtration). Examples of a dialysis membrane may include: cellulose-based membranes, such as cellulose acetate; and synthetic polymer-based membranes, such as ethylene vinyl alcohol, polyacrylonitrile, polymethyl methacrylate, polysulfone, and polyethersulfone. The molecular weight cut-off of the dialysis membrane is usually 5,000 to 100,000, preferably 7,000 to 80,000, more preferably 10,000 to 50,000.

Instead of the dialysis treatment, ultrafiltration treatment (UF treatment) can be used. A known UF membrane can be used. Examples of the UF membrane may include a hollow-fiber membrane, a spiral membrane, a tubular membrane, and a flat membrane. Any known material for the UF membrane can be used. Examples of the material may include cellulose acetate, aromatic polyamide, polyvinyl alcohol, polysulfone, polyvinylidene fluoride, polyethylene, polyacrylonitrile, and ceramic. Note that the UF membrane may be a commercial product.

The molecular weight cut-off of the UF membrane is preferably 5,000 to 30,000, more preferably 10,000 to 25,000, still more preferably 15,000 to 23,000. The use of the UF membrane having a molecular weight cut-off of 5,000 or more can prevent the separation rate of a treatment liquid from becoming excessively slow. The use of the UF membrane having a molecular weight cut-off of 30,000 or less can prevent lignin from not being separated from a treatment liquid.

Any rate of concentration by the UF treatment using the UF membrane can be set. In other words, the UF treatment is beneficially stopped at the time when the outflow of a concentrated liquid reaches an arbitrary amount. 2 to 6 times concentration is preferred. 2 to 6 times concentration means that the amount of an undiluted solution (black liquor) is reduced to ½ to ⅙ of the initial amount.

The temperature of the treatment liquid during the UF treatment is not particularly limited. For example, the temperature is preferably 20° C. to 80° C., and, from the viewpoint of the heat resistance of a UF membrane material, the temperature is more preferably 20° C. to 70° C. The pH value of the treatment liquid in the UF treatment is preferably 2 to 11. The solids concentration (w/w) of the black liquor in the UF treatment is preferably 2% to 30%, more preferably 5% to 20%.

Examples of the modification treatment may include: chemical modification methods, such as hydrolysis, alkylation, alkoxylation, sulfonation, sulfonic acid esterification, sulfomethylation, aminomethylation, desulfonation, alkalization, and a condensation reaction with (poly)alkylene oxide; and a molecular weight cut-off method by ultrafiltration of a lignin sulfonic acid. Among them, as the chemical modification method, one or two or more of reactions selected from hydrolysis, alkoxylation, desulfonation, alkylation, and a condensation reaction with (poly)alkylene oxide (for example, WO 2021/066166) are preferred.

### [1.3 Soil Improvement Effect]

The lignin sulfonic acid component has the effect of improving soil.

### [Soil]

A target soil is beneficially natural soil, and may be any of sand, fine soil, and clay. Examples of the sand may include coarse sand, fine sand, and gravel. Examples of the soil may include andosols (such as volcanic ash soil), diluvial soils (such as red-yellow soil, brown forest soil, red forest soil, red soil, yellow soil, dark red soil, gray upland soil, and glay upland soil), and alluvial soils (such as brown lowland soil, gray lowland soil, and sand dune regosol). The plasticity of the soil is not particularly limited, hence, for example, any of heavy clayey soil, clayey soil, clay loam, loam, sandy loam, sandy soil, gravel soil, and humus soil can be used. Examples of the use for the soil may include agricultural use (for example, paddy soil, upland soil, forest soil, grassland soil (for example, for grazing lands or racetracks)), civil engineering use, and green land use (for example, lawn grass and flower beds in garden areas, parks, schools, facilities, and the likes). Although not particularly limited, the use for the soil is preferably agricultural use.

Examples of soil improvement may include an increase in the amount of inorganic components (such as phosphorus atoms and iron atoms) in soil, microbial growth in soil, dispersion of pesticides in soil, and promotion of aggregate of soil.

### [1.4 Biostimulant]

The lignin sulfonic acid component can improve the physiological state of plants and soils by utilizing the natural power inherent in plants and their surrounding environments and thereby cause the growth of microorganisms in soil and convert inorganic components (such as phosphorus, nitrogen, and iron) in a form incapable of being absorbed as nutrients into a form capable of being absorbed, and therefore can be used also as a biostimulant for soil. When the lignin sulfonic acid component is used as a biostimulant, a target plant is the same as that mentioned in the description about the soil conditioner.

### [1.5 Optional Component]

Each of the above-mentioned agents (the soil conditioner and the biostimulant) may include a component (an optional component) other than the lignin sulfonic acid component as necessary. Examples of the optional component may include optional components (formulation aids), such as soil conditioner components other than the lignin sulfonic acid component (such as saccharides (for example, glucose), inorganic components, and polycarboxylic acids), biostimulants other than the lignin sulfonic acid component, an excipient, a colorant, a preservative, a pH regulator, a stabilizer, a disintegrator, a carrier, a binder, a pH adjuster, a defoaming agent, a nonionic surfactant, a cationic surfactant, and an amphoteric surfactant.

Examples of the inorganic components as the soil conditioner components may include: inorganic salts, such as nitrogen, phosphorus, and potassium as essential elements, and sulfur, calcium, magnesium, iron, manganese, zinc, boron, molybdenum, chlorine, iodine, and cobalt as micronutrients; oxides thereof; and inorganic salts containing them. Examples of the inorganic salts may include magnesium hydroxide, magnesium oxide, calcium carbonate (slaked lime), potassium nitrate, ammonium nitrate, ammonium chloride, sodium nitrate, potassium monohydrogen phosphate, sodium dihydrogen phosphate, potassium oxide, potassium chloride, potassium sulfate, ammonium sulfate, magnesium sulfate, calcium sulfate, ferrous sulfate, ferric sulfate, manganese sulfate, zinc sulfate, copper sulfate, sodium sulfate, calcium chloride, magnesium chloride, boric acid, molybdenum trioxide, sodium molybdate, potassium iodide, cobalt chloride, calcium phosphate monobasic, mixtures thereof (for example, calcium superphosphate (a mixture of calcium phosphate monobasic and calcium sulfate)), and hydrates thereof.

Examples of the other biostimulants may include biologically derived materials (for example, organic acid such as humic acid and fulvic acid, humus; seaweed; microorganisms, such as Trichoderma, mycorrhiza, yeast, Bacillus subtilis, and root nodule bacteria: plants and animals; and metabolites thereof), extractive seaweed-derived materials (seaweed and extracts thereof), saccharides (for example, polysaccharides), peptides (including amino acids), minerals, and vitamins.

Regarding the amount of optional components contained, an appropriate amount is selected for each optional component.

### [1.6 Formulation, Production Method]

The formulations of the above-mentioned agents (the soil conditioner and the biostimulant) are not particularly limited, and examples thereof may include powder, microgranular, granular, and liquid formulations. A microgranular or granular formulation can lead to the easiness of spraying. A liquid formulation can lead to easiness of mixing with a functional component and thereby lead to stabilization of a slurry after the mixing. The agents may be formulated together with a functional component or may be formulated separately. An appropriate method for producing the agents can be suitably selected in accordance with the formulations.

### [2. Improved Soil Composition]

Soil to which the above-mentioned soil conditioner or the biostimulant is added can be used for agriculture, civil engineering, and the like as an improved soil composition and is preferably used for agriculture. Thus, an increased crop yield and realization and popularization of organic agriculture can be expected.

The content of the agents in the improved soil composition as the amount of the lignin sulfonic acid component is usually 0.000001% by weight or higher, preferably 0.00001% by weight or higher, more preferably 0.00005% by weight or higher in terms of the weight of soil. The upper limit of the content of the agents is not particularly limited and is usually 10% by weight or lower.

The improved soil composition may include other components besides the soil conditioner or the biostimulant according to the present invention and soil. Examples of the other components may include a soil conditioner other than the soil conditioner according to the present invention, and artificial soils (for example, artificial soils such as rice husk charcoal, coconut fiber, vermiculite, perlite, peat moss, glass beads, and rice husks; porous moldings, such as foamed phenolic resin and rock wool; solidifying agents (such as agar and gellan gum), and a combination of two or more of them). Regarding the content of the other components, an appropriate amount is selected for each component.

### [3. Method for Preparing Improved Soil Composition]

The improved soil composition is beneficially prepared by adding the soil conditioner or the biostimulant to soil. A stirrer may be used for mixing as necessary. The other components other than the soil conditioner and the soil may be added to the soil together with the soil conditioner or may be sequentially added.

### [4. Method for Plant Production]

The improved soil composition can be used for plant production.

### [Plant]

Examples of a target plant may include an herbaceous plant and a woody plant. Examples of the herbaceous plant may include Cruciferae, Leguminosae, Cucurbitaceae, Solanaceae, Capsicum annum, Rosaceae, Malvaceae, Poaceae, Allium, Amaryllidaceae, Compositae, Amaranthaceae, Umbelliferae, Zingiberaceae, Labiatae, Araceae, Convolvulaceae, Dioscoreaceae, and Nelumbonaceae. Specific examples of the herbaceous plant may include: green vegetables, such as Brassica campestris var. komatsuna, Chinese cabbage, onion, leek, garlic, Allium chinense, Allium tuberosum, Cruciferae, bok choy, cabbage, cauliflower, broccoli, Brussels sprouts, asparagus, lettuce, salad greens, celery, spinach, garland chrysanthemum, parsley, Japanese hornwort, Oenanthe javanica, Aralia cordata, Zingiber mioga, Japanese butterbur, and Perilla frutescens var. crispa; fruit vegetables, such as soybean, green soybean, broad bean, pea, cucumber, eggplant, melon, corn, pumpkin, watermelon, tomato, green pepper, strawberry, okra, and string green bean; root vegetables, such as carrot, turnip, radish, burdock, potato, taro, sweet potato, Japanese yam, ginger, and lotus root; Poaceae (for example, paddy rice, upland rice); wheats (for example, wheat, barley); and flowers and ornamental plants. Examples of the woody plant may include: Cryptomeria japonica (for example, Japanese cedar), Chamaecyparis obtusa (for example, Japanese cypress), Pinaceae (Pinus (for example, Pinus thunbergii), Larix (for example, Larix leptolepis, Larix gmelini), Abies (for example, Abies sachalinensis)), Eucalyptus (for example, Eucalyptus globulus), Prunus (for example, cherry tree, plum, and Prunus tomentosa), Mangifera indica (for example, mango), Acacia, Myrica rubra, Quercus acutissima (for example, sawtooth oak), Vitaceae, Malus pumila, Rosa, Camellia (for example, Thea sinensis) Jacaranda (for example, jacaranda), Persea americana (for example, avocado), Pyrus spp. (for example, pear), and Santalaceae (for example, Santalum album (sandalwood)). Among them, herbaceous plants are preferred, and cruciferous and leguminous plants are more preferred.

The improved soil composition may be used in the whole of a plant growth period or in a part of the period. Furthermore, the improved soil composition may be used not only for crop breeding from seeds or seedlings, but also for tissue culture for a cutting, a scion, or the like.

In plant production using the improved soil composition, plant cultivation conditions (such as temperature, light intensity, irrigation amount, humidity, carbon dioxide concentration, with or without the adjustment of them, seeding density, irrigation method, irrigation amount, using or not using cultivation facilities and containers (for example, a planter, a pot, a vat, a container, a cell tray)) are not particularly limited and can be suitably selected. A fertilizer may be added to the improved soil composition. Examples of the fertilizer may include components that can supply plant nutrients, such as an inorganic component, silver ions, an antioxidant, a carbon source, vitamins, amino acids, and phytohormones. The form of the additives is not particularly limited and the additives can be in any form of a solid (such as powder or granules) and a liquid (such as a liquid fertilizer).

### EXAMPLE

Hereinafter, the present invention will be described using examples. The following examples are not intended to limit the present invention.

Compositions of main samples used in the examples are illustrated in Table 1.

TABLE 1
Table 1. Main samples used in Examples

| | | | Sample 3 | Sample 4 |
|---|---|---|---|---|
| | | Sample 2 | Lignin | AZUMIN |
| | | Lignin | sulfonic | (manu- |
| | Sample 1 | sulfonic acid | acid | factured |
| | Lignin | (reducing— | (Na salt, | by Denka |
| | sulfonic | sugars | increased | Company |
| Sample | acid | reduced) | purity) | Limited) |
| Phenolic | 1.24 | 1.75 | 2.52 | 1.26 |
| hydroxyl | | | | |
| group ^{*2} | | | | |
| [%] ^{*1} | | | | |
| Carboxyl | 1.25 | 2.44 | 0.53 | 1.31 |
| group | | | | |
| ^{*3} [mmol/g] | | | | |
| Reducing | 21.60 | 7.06 | 0.95 | 22.19 |
| sugars ^{*4} | | | | |
| [%] ^{*1} | | | | |
| OCH₃^{*5} | 6.52 | 7.83 | 11.21 | 6.82 |
| [%] ^{*1} | | | | |
| S^{*6} [%] ^{*1} | 7.81 | 6.69 | 7.12 | 5.45 |
| SO₃^{*7} [%] ^{*1} | 0.19 | 0.05 | 0.02 | 0.59 |
| SO₄^{*7} [%] ^{*1} | 8.24 | 4.32 | 1.00 | 1.50 |
| Sulfone | 5.0 | 5.23 | 6.8 | 4.82 |
| group | | | | |
| S ^{*8} [%] ^{*1} | | | | |
| Weight | 4,100 | 4,700 | 12,900 | 4,400 |
| average | | | | |
| molecular | | | | |
| weight Mw | | | | |
| (RI)^{*9} | | | | |
| Weight | 7,000 | 7,800 | 14,300 | 5,000 |
| average | | | | |
| molecular | | | | |
| weight Mw | | | | |
| (UV)^{*10} | | | | |
| Ca^{*11} [%] ^{*1} | 0.43 | 0.88 | 0.04 | 2.31 |
| Na^{*11} [%] ^{*1} | 1.2 | 1.66 | 6.1 | 0.55 |
| Mg^{*11} [%] ^{*1} | 3.8 | 3.7 | 0.2 | 0.97 |

[Footnotes to Table 1]
^{*1} “%” represents percent by mass of the dry weight of a sample.
^{*2} Phenolic hydroxyl group content
From the absorption spectrum of an alkaline solution including a lignin sample, the absorption spectrum of a neutral solution including lignin with the same concentration was subtracted to obtain an ionization differential spectrum, and the phenolic hydroxyl group content (%) was determined using the following formula. In the formula, Δαmax [L/(g · cm)] represents a differential absorption coefficient (Nakano Junzo (ed.), “Chemistry of Lignin—Basics and Applications—enlarged and revised edition” (Lignin no kagaku—kiso to ohyo—(in Japanese)), Uni Press, May 25, 1990, p. 541).
$Phenolic hydroxyl group content ( \% ) = ( 17 \times Δα max ) / 4100 \times 100$ ^{*3} Carboxyl group content
60 ml of 0.5% by mass of a water dispersion of a sample was prepared, and a 0.1M hydrochloric acid aqueous solution was added thereto to adjust to pH 2.5. Subsequently, a 0.05N sodium hydroxide aqueous solution was added dropwise and an electrical conductivity was measured until the pH reached 11. From the amount (a) of sodium hydroxide consumed during the neutralization of weak acid with a slow change in electrical conductivity, the carboxyl group content was calculated using the following formula:
carboxyl group content [mmol/g sample] = a [ml] × 0.05/mass of sample
^{*4} Reducing sugar content
The reducing sugar content of a lignin fertilizer was calculated by converting a value measured by the Somogyi-Schaffer method into a glucose content.
^{*5}Methoxyl (OCH₃) group content
The methoxyl group content of lignin was determined by the method of quantitative determination of methoxyl groups in accordance with the Viebock and Schwappach method (“Lignin Chemistry Methodology” (lignin kagaku kenkyuho (in Japanese)), published by Uni Press, 1994, pp. 336-340).
^{*6}Total sulfur atom (S) content
The S content was determined by ICP emission spectrometry.
^{*7}Sulfur oxide (SO₃, SO₄) content
SO₃ content and SO₄ content were each quantitatively determined by ion chromatography.
^{*8} Sulfur atom (S) content of sulfone group
The S content of a sulfone group was determined by the following formula.
S content of sulfone group (% by mass) = S content (% by mass) − inorganic form S content (% by mass)
In the formula, percent by mass represents a ratio of the S content to the solids content of lignin sulfonic acid. The S content is a value measured by the method described above. The inorganic form S content represents the total amount of the SO₃ content and the SO₄ content determined by the method described above.
^{*9}Weight average molecular weight (RI)
The weight average molecular weight (RI) was determined by gel permeation chromatography (GPC) under the following conditions.
Measuring device: manufactured by Tosoh Corporation
Columns used: Shodex Column OH-pak SB-806HQ, SB-804HQ, SB-802.5HQ
Eluent: 0.05 mM sodium nitrate/acetonitrile 8/2 (v/v)
Reference material: polyethylene glycol (manufactured by Tosoh Corporation or GL Sciences Inc.)
Detector: Differential refractometer (manufactured by Tosoh Corporation)
Calibration curve: polyethylene glycol standard
^{*10}Weight average molecular weight (UV)
The weight average molecular weight (UV) was determined under the same conditions as for the weight average molecular weight (RI) by the above-described RI detection, except that a UV detector (280 nm, manufactured by Tosoh Corporation) was used as a detector.
^{*11}Ca content, Na content, Mg content
Metal ions (Ca²⁺, Na⁺, and Mg²⁺) were quantitatively determined by the inductively coupled plasma (ICP) method, and quantitative determination results were respectively converted into a Ca content, a Na content, and a Mg content (% by mass).

### Production Example 1: Production of Sample 1

Wood (radiata pine) was subjected to sulfite treatment based on sulfite cooking, whereby an intermediate composition was obtained. The sulfite treatment was performed using a magnesium sulfite solution having a SO₂ concentration of 4 g/100 mL at a temperature of 140° C. and pH 2 for a treatment time of 3 hours. Subsequently, insoluble substances were filtered off and the resulting filtrate was concentrated by a rotary evaporator until the solids content reached 50%, whereby an intermediate composition A was obtained. The resulting intermediate composition A was subjected to spray-drying, whereby a solidified composition, namely, sample 1 was obtained.

### Production Example 2: Production of Sample 2

The intermediate composition A obtained in Production Example 1 was subjected to an alkaline reaction (the addition rate of a calcium hydroxide solution: 9 wt % (with respect to solid contents), reaction temperature: 90° C., reaction time: 4 hours) and an oxidation reaction (treatment with oxygen, oxygen pressure: 200 kPa, reaction time: 2 hours), and the pH of the resulting intermediate composition A was adjusted to 7.0. The resulting intermediate composition A was subjected to spray-drying, whereby a solidified composition, namely, sample 2 was obtained.

### Production Example 3: Production of Sample 3

Wood (radiata pine) was subjected to sulfite treatment based on sulfite cooking, whereby an intermediate composition was obtained. The sulfite treatment was performed using a sodium sulfite solution having a SO₂ concentration of 4 g/100 mL at a temperature of 140° C. and pH 2 for a treatment time of 3 hours. Subsequently, insoluble substances were filtered off, and the pH of the resulting filtrate was adjusted to 5.0. The resulting filtrate was subjected to ultrafiltration using a polysulfone-based ultrafiltration membrane having a molecular weight cut-off of 20,000, and the resulting concentrated liquid was spray-dried, whereby a solidified composition, namely, sample 3, was obtained.

### Test Example 1: Effect on Microbial Activity

### Examples 1 to 3 and Comparative Examples 1 and 2

### [Amount of Carbon Dioxide Generated]

Each of the samples listed in Table 2 was mixed with volcanic ash soil (from Kitamoto, Saitama Prefecture) or red-yellow soil (from Takashigahara, Aichi Prefecture) to prepare a soil sample, and the soil sample was allowed to stand at a temperature of 26.5° C. and a humidity of 50%. The amount of carbon dioxide contained in the soil sample after a lapse of 30 days following the preparation was measured using a carbon dioxide absorbent in accordance with the following procedure. The soil sample and 8 mL of 0.1N NaOH were put into a beaker and incubated for 24 hours, and then 1 mL of 50% barium chloride was added thereto, whereby a white precipitate of carbon dioxide absorbed in NaOH was formed. The remaining sodium hydroxide was titrated with 0.1 N hydrochloric acid by using phenolphthalein as an indicator.

50 g of the soil sample of volcanic ash soil was filled into a reflux device and 0.3 L of a culture solution (composition: 1.2% lignin solution) was refluxed for 7 days, and then the number of colonies in each of the reflux liquid and the reflux soil was measured by a usual method using a dilution plate method (medium: albumin agar medium (0.25 g/L of egg albumin, 1.0 g/L of glucose, 0.5 g/L of K₂HPO₄, 0.2 g/L of MgSO₄·7H₂O, 1 mL of 1% o Fe (SO₄)₃, 18 0.0 g/L of Agar, pH 6.8 to 7.0) was used, an incubation period of 14 days at 26.5C) (N=1: Table 3)

TABLE 2
Sample used for microbial activity test (unit: mg per 100 g of soil)

| | | | | Low | | |
|---|---|---|---|---|---|---|
| | Sample used | | | molecular | | |
| | and Amount | Lignin | | weight | Ash on | |
| | of sample | sulfonic | Reducing | organic | ignition | |
| No. | added | acid *² | sugars | substance*¹ | *² | S |
| Comparative | Not added | — | — | — | — | — |
| Example 1 | | | | | | |
| Example 1 | Sample 2 | 510 | 44 | 115 | 108 | 50 |
| | 1% | | | | | |
| Example 2 | Sample 2 | 51 | 4.4 | 11.5 | 10.8 | 5.0 |
| | 0.1% | | | | | |
| Example 3 | Dialysis | 977 | 0.14 | 14 | 70 | 51 |
| | product of | | | | | |
| | sample 2 | | | | | |
| | 1%*⁶ | | | | | |
| Comparative | Glucose | — | 0.14 | — | — | — |
| Example 2 | *⁷0.014% | | | | | |
| No. | Sample used | Total | Total | SO₂*⁴ | C*⁵ | |
| | and Amount | MgO*³ | CaO*³ | | | |
| | of sample | | | | | |
| | added | | | | | |
| Comparative | Not added | — | — | — | — | |
| Example 1 | | | | | | |
| Example 1 | Sample 2 | 56 | 18 | 1.5 | 433 | |
| | 1% | | | | | |
| Example 2 | Sample 2 | 5.6 | 1.8 | 0.15 | 43.3 | |
| | 0.1% | | | | | |
| Example 3 | Dialysis | 37 | 20 | 5 | 466 | |
| | product of | | | | | |
| | sample 2 | | | | | |
| | 1%*⁶ | | | | | |
| Comparative | Glucose | — | — | — | 0.14 | |
| Example 2 | *⁷0.014% | | | | | |

[Footnotes to Table 2]
*¹A low-molecular weight organic substance was measured using an anthrone chromophore water-soluble matter (4 times as much as oven-dry soil).
Water-soluble substance: leached out in 4 times the amount of water with respect to oven-dry soil
Acid-soluble substance: leached out in 4 times the amount of a 0.5N—H₂SO₄ solution with respect to oven-dry soil
For both the substances, 5 mL of a sample (10 to 100 g in terms of glucose) and 10 mL of an anthrone reagent (a solution of 0.2% anthrone and 95% H₂SO₄) were put into a test tube (23 mm in diameter) and allowed to cool. After the cooling, colorimetric quantification was performed with a reference material (glucose) at 625 nm.
Organic acid: 40 mL of the water-soluble substance was neutralized with 1N—NaOH, and then concentrated to dryness under reduced pressure. 40 mL of the acid-soluble substance was subjected to continuous liquid ether extraction for 48 hours, and an extract was neutralized and then concentrated to dryness under reduced pressure. For each of the resulting substances, fractional quantification of organic acids was performed by silica gel column chromatography.
Note that fraction I indicates butyric acid, propionic acid, valerianic acid, and the like, fraction II indicates acetic acid, fraction III indicates formic acid and pyruvic acid, and fraction IV indicates lactic acid, succinic acid, and the like. The amount of fraction II is illustrated as the amount of the organic acid in Table 2.
*² The content of ash on ignition was determined by ashing at 550° C. in accordance with JIS P 8251: 2003 “Paper, board and pulps -Determination of residue (ash) on ignition-”.
*³The total content of CaO and the total content of MgO were determined by measuring Ca and Mg by ICP in terms of their respective oxides.
*⁴The SO₂ content was determined by ion chromatography.
*⁵Six-fold dilution with a 1/10 to 1/15M monopotassium phosphate solution was performed to produce a slightly acidic condition, then exposure to N2 gas was performed to remove dissolved carbon dioxide, and the carbon content C was measured by a total organic carbon meter.
*⁶Dialysis lignin is a dialysis product of sample 2. Dialysis was performed using a dialysis membrane (BIOTECH CE TRIAL KIT, manufactured by Funakoshi Co., Ltd.) under a condition of 3.5 to 5.0 kDa fractionation.
*⁷As the glucose, D-(+)-Glucose, manufactured by FUJIFILM Wako Pure Chemical Corporation, was used.
Note that reducing sugars and sulfur were quantitatively determined by the methods described in the footnotes in Table 1.

TABLE 3
Microbial activity test result

| | | Amount of CO₂ | | | |
|---|---|---|---|---|---|
| | | generated | | Number of | |
| | | | Red- | colonies on 7^{th} | |
| | | Volcanic | yellow | day after start | |
| | | ash soil | soil | of reflux | |
| | | CO₂ | CO₂ | Volcanic ash | |
| | | mol/100 g | mol/100 g | soil | |
| | Sample | of oven- | of oven- | Reflux | Reflux |
| No. | used | dry soil | dry soil | liquid | soil |
| Comparative | Not added | 45.7 × 10⁻⁴ | 16.3 × 10⁻⁴ | 1.0 × 10^{2.9} | 1.0 × 10^{6.5} |
| Example 1 | | | | | |
| Example 1 | Sample 2 | 114.3 × 10⁻⁴ | 93.5 × 10⁻⁴ | 1.0 × 10^{4.6} | 1.0 × 10^{7.3} |
| | 1% | | | | |
| Example 2 | Sample 2 | 54.6 × 10⁻⁴ | 24.0 × 10⁻⁴ | — | — |
| | 0.1% | | | | |
| Example 3 | Dialysis | 56.1 × 10⁻⁴ | 33.2 × 10⁻⁴ | — | — |
| | product of | | | | |
| | sample 2 | | | | |
| | 1% | | | | |
| Comparative | Glucose | 44.9 × 10⁻⁴ | 18.7 × 10⁻⁴ | — | — |
| Example 2 | 0.014% | | | | |

In the soil samples of Examples 1 to 3 (of both the volcanic ash soil and the red-yellow soil) in which the lignin sulfonic acid-containing sample was used, the amount of carbon dioxide generated was larger than in Comparative Examples 1 and 2 (Table 3), and this indicated that the addition of lignin sulfonic acid improved a growth environment for microorganisms. The number of colonies in each of the reflux liquid and the reflux soil in Example 1 was larger than in Comparative Example 1, in which the sample was not added, and this indicated that a growth environment for microorganisms such as bacteria was improved and the soils were activated (Table 3).

### Test Example 2: Effect on Divalent Iron Ion Content of Paddy Field Plow Layer (Examples 4 and 5 and Comparative Example 3)

The samples listed in Table 4 were each added in amounts listed in Table 4 to 7.2 g of 2-mm or smaller size air-dried fine soil (from a paddy field plow layer in Nagano Prefecture) and collected in a 20-mL (±5 g) syringe, and furthermore, 10 g of water was collected to perform flooding (to reproduce a paddy field state), and then incubation was performed in a thermostatic chamber at 26.5° C. for 35 days. The ratio of the air-dried fine soil to the water was adjusted to (1:2). The samples on the 0th, 2nd, 7th, 14th, 21st, and 35th day after the start of the incubation were each extracted using a 1M sodium acetate-hydrochloric acid buffer solution having a pH of 2.8, and colorimetry was performed for divalent iron ions (FeII) by the orthophenanthroline method. In other words, the amount of divalent iron ions was calculated using a calibration curve produced by the following method (N=1: Table 5).
1. 0.0, 0.2, 0.4, 0.6, and 0.8 mL of standard iron solutions (50 pa/mL) were precisely taken into five 10-mL measuring flasks, respectively, by using a measuring pipette.
2. After 0.4 mL of 6 mol/L hydrochloric acid was added to each of the solutions, 0.25 mL of a hydroxylammonium chloride solution (100 g/L) was added thereto and shaken.
3. After 0.5 mL of a phenanthroline solution (1 g/L) and 1 mL of an ammonium acetate solution (500 g/L) were added to the resulting mixture, ion-exchanged water was added thereto to precisely prepare a 10-mL solution.
4. Absorbance at 510 nm was measured using ion-exchanged water as a reference.

TABLE 4
Addition amount and Composition of sample used

| | | In sample | | | | | |
|---|---|---|---|---|---|---|---|
| | | | | | | | Sulfone |
| | | Reducing | | | | | group- |
| | Sample | sugars | OCH₃ | S | SO₃ | SO₄ | derived |
| No. | used | [%] | [%] | [%] | [%] | [%] | S [%] |
| Comparative | Not | — | — | — | | | — |
| Example 3 | added | | | | | | |
| Example 4 | Sample 2 | 7.06 | 7.83 | 6.69 | 0.05 | 4.32 | 5.23 |
| | 0.1% | | | | | | |
| Example 5 | Sample 2 | 7.06 | 7.83 | 6.69 | 0.05 | 4.32 | 5.23 |
| | 1.0% | | | | | | |

TABLE 5
Divalent iron ion measurement result

| | | Divalent iron ion content | | | | | |
|---|---|---|---|---|---|---|---|
| | | [unit: μg/ml] | | | | | |
| | | 0^{th} | 2^{nd} | 7^{th} | 14^{th} | 21^{st} | 35^{th} |
| No. | Sample used | day | day | day | day | day | day |
| Comparative | Not added | 0 | 23 | 200 | 362 | 474 | 600 |
| Example 3 | | | | | | | |
| Example 4 | Sample 2 0.1% | 5 | 64 | 273 | 481 | 547 | 656 |
| Example 5 | Sample 2 1.0% | 35 | 71 | 350 | 575 | 694 | 717 |

In Examples 4 and 5 in which lignin sulfonic acid was contained, the divalent iron ion content was higher than in Comparative Example 3, in which the sample was not added, and, in particular, in Example 5, the divalent iron ion content was significantly higher (Table 5).

### Test Example 3: Effect on Phosphoric Acid Penetration (Examples 6 and 7 and Comparative Example 4)

Air-dried soil (diluvial volcanic ash unfertilized soil, heavy clay soil, and diluvial red forest soil) was put through a 2-mm sieve and a part of the soil having passed through the sieve was used as a sample soil (Table 6). 50 g of the sample soil was weighed and taken into a 500-mL beaker, and 225 mL of the following P-containing aqueous solution was added thereto and stirred well, and then the resulting mixture was allowed to stand for 24 hours at room temperature. Water was added to the mixture to obtain a total of 500 mL of a paddy water sample containing the soil. The paddy water sample was filtered through dry filter paper (Toyo Roshi No. 5A). A part of the filtrate was evaporated to dryness in an aluminum measuring dish, and the count (C.P.M.: Counter Per Minute) thereof was measured using a G.M. Counter and compared with the count of standard P, and a value of the total P in the paddy water sample was calculated. The ratio of phosphate absorption was expressed as % of P³² adsorbed to the soil with respect to the total P added (N=1: Table 7). The P³² used was an orthophosphate solution (pH 2 to 3) manufactured by the Radiochemical Centre, UK and having a radiochemical purity >99%.

### [P-Containing Aqueous Solution]

P₂O₅ 550 mg (NaH₂PO₄)
N 50 mg (NH₄Cl)
K 50 mg (KCl)

The lignin samples of 0.0001% (=0.05 mg) and 0.001% (=0.5 mg) with respect to the soil were each dissolved in a P-containing aqueous solution.

TABLE 6
Composition of sample soil

| | | Weight ratio with respect to sample soil | | | | | |
|---|---|---|---|---|---|---|---|
| | | Reducing | | | | | Sulfone |
| | Sample | sugars | OCH₃ | S | SO₃ | SO₄ | group-derived |
| No. | used | [%] | [%] | [%] | [%] | [%] | S [%] |
| Comparative | Not | — | — | — | — | — | — |
| Example 4 | added | | | | | | |
| Example 6 | Sample 2 | 7.06 | 7.83 | 6.69 | 0.05 | 4.32 | 5.23 |
| | 0.1% | | | | | | |
| Example 7 | Sample 2 | 7.06 | 7.83 | 6.69 | 0.05 | 4.32 | 5.23 |
| | 1.08 | | | | | | |

TABLE 7
Phosphoric acid penetration test result

| | | Phosphoric acid remaining in | | |
|---|---|---|---|---|
| | | paddy water (calculated value: %) | | |
| | | Diluvial | | |
| | | volcanic ash | Heavy | Diluvial |
| | Sample | unfertilized | clay | red forest |
| No. | used | soil | soil | soil |
| Comparative | Not added | 13 | 41.2 | 58.4 |
| Example 4 | | | | |
| Example 6 | Sample 2 | 26 | 63 | 76 |
| | 0.0001% | | | |
| Example 7 | Sample 2 | 23 | 50 | 63 |
| | 0.001% | | | |

In Examples 6 and 7 in which lignin sulfonic acid was used, the amount of phosphoric acid remaining in the paddy water in each of the soils was larger than in Comparative Example 4, in which the sample was not added (Table 7).

### Test Example 4: Calcium Carbonate Dispersion Test (B-Type Viscosity Test) (Example 8, Comparative Examples 5 and 6)

Effects on the dispersibility of calcium carbonate used as an extending agent for agrochemicals were evaluated.

To 172.44 g of calcium carbonate (water content of 30%), 37.56 g of water and each of the dispersants listed in Table 8 were added and stirred, whereby a slurry was prepared. The concentration of the slurry including water and calcium carbonate was 57%, and the amount of each of the dispersants added (solids addition rate) was 0.050 or 0.1% with respect to the total amount of the slurry. The stirring was performed using a homo disperser at 3000 rpm for 2 minutes. Using a B-type viscometer (manufactured by Toki Sangyo Co., Ltd.), the B-type viscosity of the slurry after the stirring was measured at 20° C. and 60 rpm by a No. 3 rotor or a No. 2 rotor without a guard (Table 8).

TABLE 8
Test result

| | | | B-type |
|---|---|---|---|
| | | | viscosity |
| | Sample | Solids addition rate (%) | (mPa · s) |
| Comparative | Water | 0 | 724 |
| Example 5 | only | 0 | 730 |
| Example 8 | Sample 3 | 0.05 | 443 |
| | | 0.10 | 223 |
| Comparative | Sample 4 | 0.05 | 752 |
| Example 6 | | 0.10 | 690 |

Example 8 in which sample 3 was used had a lower viscosity than Comparative Example 5 in which only water was used.

### Test Example 5: Aggregation Effect (Examples 9 to 13 and Comparative Examples 7 and 8)

50 to 100 g of each of the soils to be tested (Table 9) was taken in a petri dish (90 mm×20 mm) or a beaker (200 cc), and the sample was applied thereto in amounts (% by weight: with respect to absolute dry soil) listed in Tables 9 and 10 and stirred well, and then water is added in the amount of 60% of the maximum amount of water brought and incubation was performed at 30° C. for 7 days. After the incubation, air-drying was performed for 5 to 7 days to obtain a sample for aggregate analysis (N=3). The aggregate analysis was performed by a usual method with sieving in water. The results of the analysis were expressed in terms of the degree of aggregation of 0.25-mm or smaller size particles, and comparisons on aggregate formation ability were performed. The degree of aggregation was calculated using the following formula.

$$Degree of aggregation ( \% ) = \{ ( Secondary particles - Primary particles ) / Amount of absolute dry soil to be tested \} \times 100$$

TABLE 9
Relationship between aggregation and type of soil additive
(sample 2, 6: 0.1% by weight added) (unit: %)

| | Example | Comparative | Sample |
|---|---|---|---|
| | 9 | Example 7 | 2 |
| Soil to be tested | Sample 2 | Sample 4 | Blank |
| | | AZUMIN | |
| Heavy clayey upland soil | 19.4 | 18.5 | 17.2 |
| from Kayagatake | | | |
| Light-colored Andosols | 41.6 | 34.0 | 40.8 |
| volcanic ash upland soil | | | |
| Diluvial upland soil from | 16.2 | 15.8 | 12.4 |
| Saijo | | | |
| Diluvial forest soil from | 35.4 | 33.2 | 25.6 |
| Saijo | | | |

TABLE 10
Relationship between amount of lignin sulfonic acid component
(sample 2) added and degree of aggregation (unit: %)

| | Example | Example | Example | Example |
|---|---|---|---|---|
| | 10 | 11 | 12 | 13 |
| Soil to be tested | Addition amount | | | |
| | (%: with respect to absolute dry soil) | | | |
| | 1.0 | 0.5 | 0.25 | Blank |
| Heavy clayey upland | 21.6 | 23.8 | 22.8 | 20.0 |
| soil from Kayagatake | | | | |
| Alluvial paddy soil | 30.4 | 30.8 | 28.4 | 26.6 |
| from Kounosu | | | | |
| Diluvial upland soil | 36.4 | 31.4 | 32.6 | 21.8 |
| from Iwatahara | | | | |
| Light-colored Andosols | 40.0 | 41.8 | 44.4 | 38.6 |
| volcanic ash upland | | | | |
| soil | | | | |
| Diluvial upland soil | 38.3 | 32.3 | 24.6 | 14.1 |
| from Saijo | | | | |
| Diluvial forest soil | 36.5 | 35.9 | 30.0 | 23.7 |
| from Saijo | | | | |

The lignin sulfonic acid component was more effective in aggregation than AZUMIN, and tended to exhibit a higher effect of aggregation, depending on the amount of the lignin sulfonic acid added.

The results of Examples revealed that the lignin sulfonic acid component was useful as a soil conditioner because the lignin sulfonic acid component exhibited good dispersibility in soil and was capable of enhancing the dispersibility of other components added at the same time, and was capable of causing better blending with soil and thereby enhancing the effects of aggregation formation and the like. Furthermore, these results were brought presumably because better physiological conditions were given to soil, and hence the lignin sulfonic acid was useful also as a biostimulant. The use of the lignin sulfonic acid according to the present invention as a biostimulant not only can cause improvement in crop quality such as reducing the number of rotten crops and increasing yields, but also can improve yields by increasing a fertilizer effect.

1. A soil conditioner, comprising:
a lignin sulfonic acid having a phenolic hydroxyl group content of 0.1% to 5.0% by weight;
a methoxyl group content of 1.0% to 15.0% by weight; and
a sulfone group-derived sulfur atom content of 2.0% by weight or higher.

2. The soil conditioner according to claim 1, wherein the lignin sulfonic acid has at least one of:
a sulfur atom content of 1.0% by weight or higher,
a sodium atom content of 0.3% by weight or higher, and
a reducing sugar content of 0.1% by weight or higher.

3. The soil conditioner according to claim 1, wherein the lignin sulfonic acid has a carboxyl group content of 0.1 to 4.5 mmol/g.

4. The soil conditioner according to claim 1, wherein a weight average molecular weight (RI) of the lignin sulfonic acid is 3,000 or more.

5. The soil conditioner according to claim 1, wherein the lignin sulfonic acid comprises a substituent derived from (poly)alkylene oxide.

6. The soil conditioner according to claim 1, which is suitable for agricultural soil.

7. A biostimulant for a soil, comprising:
a lignin sulfonic acid having a phenolic hydroxyl group content of 0.1% to 5.0% by weight;
a methoxyl group content of 1.0% to 15.0% by weight; and
a sulfone group-derived sulfur atom content of 2.0% by weight or higher.

8. An improved soil composition, comprising:
the soil conditioner according to claim 1; and
soil.

9. A method for preparing improved soil, the method comprising:
adding the soil conditioner of claim 1 to the soil.

10. A plant production method, comprising:
producing a plant with the improved soil composition of claim 8.

11. An improved soil composition, comprising:
the biostimulant according to claim 7; and
soil.

12. A method for preparing improved soil, the method comprising:
adding the biostimulant of claim 7 to the soil.
